(19) United States
(12) Patent Application Publication
(10) Pub. No.: US 2009/0240640 A1
(43) Pub. Date: Sep. 24, 2009

(54) Apparatus and method for predicting engine test performance from bench test data

(76) Inventors: David Alan Blain, Cherry Hill, NJ (US); Liepao Oscar Farng, Lawrenceville, NJ (US); Manuel A. Francisco, Phillipsburg, NJ (US); Glenn A. Murgacz, Woodbridge, NJ (US); Peter A. Gordon, Yardley, PA (US); Eugenio Sanchez, Pitman, NJ (US)

Correspondence Address: ExxonMobil Research and Engineering Company, P.O. Box 900, Annandale, NJ, 08801-0900, US

(21) Appl. No.: 12/381,803

(22) Filed: Mar. 17, 2009

Related U.S. Application Data
(60) Provisional application No. 61/070,331, filed on Mar. 21, 2008.

(51) Int. Cl. G06F 15/18; B01J 19/00; G01N 25/00; G06F 1/02

(52) U.S. Cl. 706/12; 422/68.1; 422/82.12; 708/274

(57) ABSTRACT

An apparatus for evaluating deposit formation characteristics of lubricant samples. The apparatus includes a reactor chamber having a closed first end and a second end, said closed first end of said reactor chamber forming a lubricant sump and said second end open to the atmosphere, an electric heater for heating a test coupon positioned thereon, said electric heater positioned within said reactor chamber, above said lubricant sump, an air supply tube, said air supply tube having a first end in fluid communication with a source of air and a second end, said second end positioned adjacent the test coupon, said air supply tube having a sample orifice located between said first end and said second end of said air supply tube and a lubricant supply tube, said lubricant supply tube having a first end positioned within said lubricant sump and in fluid communication with a source of lubricant and a second end, said second end positioned within said sample orifice of said air supply tube. A method of predicting lubricant deposit formation in an end use engine test and a method for predicting whether a candidate lubricant sample will pass an End Use Test are also provided.

### CROSS-REFERENCE TO RELATED APPLICATIONS

This application claims priority to U.S. Provisional Application Ser. No. 61/070,331 filed Mar. 21, 2008, herein incorporated by reference in its entirety.

### FIELD

This document relates generally to methods and test equipment for the screening of lubricating oil compositions. This can include, but is not limited to, high throughput screening.

### BACKGROUND

Lubricant and industrial fluid formulation research has long been acknowledged as a combination of art and science. Formulation research presents a nearly overwhelming number of variables for each possible application. Even within a given application area, a wide variety of base fluids may be used. For instance, base fluids are produced to meet required specifications. The base oils covered herein are classified by the American Petroleum Institute (API) as Group I, Group II, Group III, Group IV and Group V, which designate parametric boundaries for viscosity index, sulfur content, amount of non-paraffins and the like. However, the actual chemical composition of a base oil that meets a specific API group criteria may vary significantly from base oil to base oil.

As may be appreciated, Groups I, II, III, IV and V are broad categories of base oil stocks developed and defined by the American Petroleum Institute (API Publication 1509; www.API.org) to create guidelines for lubricant base oils. Group I base stocks generally have a viscosity index of between about 80 to 120 and contain greater than about 0.03% sulfur and/or less than about 90% saturates. Group II base stocks generally have a viscosity index of between about 80 to 120, and contain less than or equal to about 0.03% sulfur and greater than or equal to about 90% saturates. Group III stock generally has a viscosity index greater than about 120 and contains less than or equal to about 0.03% sulfur and greater than about 90% saturates. Group IV includes polyalphaolefins (PAO). Group V base stocks include base stocks not included in Groups I-IV. Table A summarizes the properties of each of these five groups.

TABLE A
Base Stock Properties

| | Saturates | Sulfur | Viscosity Index |
|---|---|---|---|
| Group I | <90% and/or | >0.03% and | ≧80 and <120 |
| Group II | ≧90% and | ≦0.03% and | ≧80 and <120 |
| Group III | ≧90% and | ≦0.03% and | ≧120 |

| | |
|---|---|
| Group IV | Polyalphaolefins (PAO) |
| Group V | All other base oil stocks not included in |
| | Groups I, II, III, or IV |

Base stocks having a high paraffinic/naphthenic and saturation nature (>90 wt %) can often be used advantageously in certain embodiments. Such base stocks include Group II and/or Group III hydroprocessed or hydrocracked base stocks, or their synthetic counterparts such as polyalphaolefin oils, GTL or similar base oils or mixtures of similar base oils

Compounding these issues is the vast variety of chemical additives which have become necessary components in today's modern lubricants. For example, lubricants commonly include additives for corrosion control, metal passivation, extreme pressure resistance, viscosity modification, detergency, acid control, etc. While one might correctly assume that the chemistries among these functional groups may vary widely, it is also recognized that the chemistries within each of these functional additive groups may vary significantly. While the properties of any one additive in any one base oil may be relatively well known, combining additives may have unexpected (beneficial or undesired) chemical interactions.

Lubricant research might be somewhat simplified if it was limited to solving this myriad of chemical interactions between additives and base oils. But in the real world, varying engine configurations presents unique flow and heat transfer properties that cause even a standardized lubricant to react differently. Currently, equipment manufacturers require that actual engine or machinery tests verify the applicability of a candidate lubricant formulation. Indeed, many Original Equipment Manufacturers (OEM) of engines or other equipment that employ lubricants, greases or functional fluids, have their own unique test to “qualify” the candidate product. Tests such as the European Union Association des Constructeurs Europeans d'Automobiles (ACEA) standards, or the United States American Petroleum Institute (API) and International Lubricant Standards Approval Committee (ILSAC) standards require large quantities of the candidate fluids tested over weeks of time under actual full-scale engine conditions. These tests are time consuming and costly.

Lubricant researchers often employ a number of lowest-common-denominator bench tests to attempt to predict how a lubricant would fare in real-world conditions. Such bench tests are designed to provide in a laboratory environment a measure of a property or performance feature of a lubricant sample. The researcher attempts to use the bench test to make a laboratory model of the conditions of actual engines or equipment. Usually, the scope of the bench tests is limited to attempting to re-create one specific aspect of the equipment's operating environment. Not being able to exactly match the intense pressure, heat, friction, load and other conditions of operating equipment, researchers make assumptions to design bench tests to isolate the variable of interest. Unfortunately, it is generally acknowledged that bench tests are, at best, weakly predictive of the single dimension of equipment conditions they attempt to mimic.

These tests too often show poor correlation to real-world results. Since these tests tend to investigate along a single dimension, they limit opportunities to discover positive or negative chemical interactions. Moreover, it is difficult, if not impossible, to determine which combination of tests, if any, would predict a binary pass/fail result for any specific OEM's end use test. These tests would most likely not give a graduated view of which base oils, additives or formulations would better pass a given OEM use test.

The current state of the art for the formulation of lubricants requires extensive formulator experience to select the optimum combination of additives and base stocks. The possible combinatorial space is quite large consisting of many different base oils and “functional families” of additives (e.g., antiwear, antioxidants, antifoaming, viscosity modifiers, dispersants, thickeners, detergents, etc.). Each functional family contains numerous different chemistries to achieve the desired function. Further complicating the formulation discovery process is that the base oils for the lubricant vary widely from highly naphthenic API Group I base oils to high purity PAO to even non-hydrocarbon based fluids such as silicones. Another complication is that the additive functional families may react differently to different base oil combinations. Indeed, one other well-known problem is that lubricant formulation chemistries are not always linear—that is, an interpolated blend of two successful lubricant chemistries does not always produce a product able to pass the same tests.

Creating a new or “step-out” lubricant formulation is severely limited by the extensive in-place engine or machinery testing that each successful candidate lubricant must pass. On average, each individual test costs between $10,000-$150,000. Sole reliance on expensive, large-scale testing to develop new lubricants (and greases), results more often in incremental formulation improvements and limits the inclusion of new, experimental components in new formulations since they require more extensive testing. Overall, sole reliance on expensive large-scale testing confines experimentation more often to the limited known-formulation performance, and it is likely that opportunities for step-out improvements in formulation technology for lubricants, functional fluids or greases are not captured.

The introduction of intermediate bench tests to lubricant formulation research can further complicate the process. Lubricant bench-tests attempt to mimic essential portions of the engine's or industrial equipment's operation, usually limiting them to a single dimension (e.g. acid value increase in a stability test at certain temperature). For example, engines may vary significantly within a product category (commercial, personal vehicle, aviation, marine or stationary industrial engines), let alone compared to other types of equipment such as, gearboxes, pumps, compressors, circulating systems and others. Any individual bench test predictive for any one engine is almost certainly not predictive of other engines or machinery.

A further complication is that equipment manufacturer's lubricant qualification tests differ even for similar equipment and are often changed on a frequent basis to reflect updated equipment technology. Typically, lubricant bench-testing is called upon to predict a large range of possible outcomes. While lubricant bench-tests are intended to allow an inexpensive measure of predictability for the more expensive large-scale tests, understanding and interpreting the correlations between bench tests and the final engine or machinery tests has often proven to be difficult. Years of experience, combined with a formulator's intuition, can help to link a successful set of bench tests to a successful large-scale, end use test or tests. Nevertheless, the formulation of lubricants, functional fluids or greases remains both an art and a science.

U.S. Pat. No. 7,069,203 proposes a method and system of transforming a product development process to reduce time in bringing a product to market through high throughput experimentation and advanced statistics and informatics, to transform the product development to a level of higher correlation with engine tests, and to develop better commercial products. This is said to be achieved by modeling in Silico a plurality of component molecular models; deriving in Silico molecular characteristics for each of the plurality of compiled molecular models; creating at least one combinatorial library database record for each of the formulations, the at least one record having a plurality fields for storing information about compositional characteristics; receiving specification requirements for a lubricating oil composition; selecting from a database entries corresponding to compositions having specifications comparable to the received specification requirements; formulating a new lubricating oil composition to comply with received specification requirements; testing the new lubricant oil for compliance with received specification requirements; repeating the selecting, formulating, and testing steps until compliance with received specification requirements is achieved; and correlating the new lubricating oil composition to actual engine performance.

U.S. Patent Publication No. 2005/0181512 proposes a method for determining deposit formation tendencies for a plurality of fluid samples of different compositions. Each sample includes one or more lubricating oil compositions including one or more base oils of lubricating viscosity and one or more lubricating oil additives. The methods may be optimized using combinatorial chemistry, in which a database of combinations of lubricating oil compositions is generated.

U.S. Patent Publication No. 2007/0032964 proposes a method that determines the necessary and sufficient tests to relate a variety of seemingly non-related tests to desired final test results. Also proposed is a method to determine those tests which, having been shown capable to be used in a high-throughput environment, are able to predict end use qualification test results for lubricants, greases or industrial fluids. As a corollary, also provided is a method to select lubricant formulations and components based on seemingly non-related, but predictive tests. Also proposed is a device and method that produces and evaluates formulated lubricants, functional fluids, and greases by determining previously unknown relationships between Intermediate Tests and End Use Tests.

Despite these advances in the art, there is a need for a methodology that can predict the performance of large scale tests.

### SUMMARY

In one aspect, provided is an apparatus for evaluating deposit formation characteristics of lubricant samples. The apparatus includes a reactor chamber having a closed first end and a second end, said closed first end of said reactor chamber forming a lubricant sump and said second end open to the atmosphere, an electric heater for heating a test coupon positioned thereon, said electric heater positioned within said reactor chamber, above said lubricant sump, an air supply tube, said air supply tube having a first end in fluid communication with a source of air and a second end, said second end positioned adjacent the test coupon, said air supply tube having a sample orifice located between said first end and said second end of said air supply tube and a lubricant supply tube, said lubricant supply tube having a first end positioned within said lubricant sump and in fluid communication with a source of lubricant and a second end, said second end positioned within said sample orifice of said air supply tube.

In another aspect, provided is a method of predicting lubricant deposit formation in an end use engine test. The method includes the steps of providing an Elemental Set of Samples having at least a first member and a second member, conducting an End Use Test for each member of the Elemental Set of Samples and obtaining a set of End Use Test Results, conducting a first deposit test for each member of the Elemental Set of Samples and obtaining a first set of Intermediate Test Results, conducting at least a second deposit test for each member of the Elemental Set of Samples, the second deposit test utilizing a different test procedure than the first deposit test, and obtaining at least a second set of Intermediate Test Results and performing a regression analysis on each set of Intermediate Test Results and the set of End Use Test Results to obtain a predictive model of lubricant deposit formation in an end use engine test.

In yet another aspect, provided is a method for predicting whether a candidate lubricant sample will pass an End Use Test. The method includes the steps of providing an Elemental Set of Samples having at least a first member and a second member, conducting an End Use Test for each member of the Elemental Set of Samples and obtaining a set of End Use Test Results, conducting a first deposit test for each member of the Elemental Set of Samples and obtaining a first set of Intermediate Test Results, conducting at least a second deposit test for each member of the Elemental Set of Samples, the second deposit test utilizing a different test procedure than the first deposit test, and obtaining at least a second set of Intermediate Test Results, performing a regression analysis on each set of Intermediate Test Results and the set of End Use Test Results to obtain a predictive model of lubricant deposit formation in an end use engine test, the predictive model including pass/fail criteria, subjecting the candidate lubricant sample to the first deposit test and the at least second deposit test and obtaining candidate lubricant sample test results and comparing the candidate lubricant sample test results with the pass/fail criteria thereby determining whether the candidate lubricant will pass the selected end use test.

In still yet another aspect, provided is a method for determining deposit formation tendencies for a plurality of fluid samples of different compositions. Each sample includes one or more lubricating oil compositions including one or more base oils of lubricating viscosity and one or more lubricating oil additives. The methods may be optimized using combinatorial chemistry, in which a database of combinations of lubricating oil compositions is generated.

In one form, the regression analysis is selected from generalized linear regression analysis and non-linear regression analysis.

In another form, the regression analysis is a neural net regression analysis.

In yet another form, each set of Intermediate Test Results is obtained by high throughput experimentation.

In still yet another form, the first set of Intermediate Test Results is obtained through the use of a two-phase high throughput deposit test.

In a further form, the second set of Intermediate Test Results is obtained through the use of a thermogravimetric analysis test procedure.

In a yet further form, the End Use Test can be the Volkswagen TDi2 End Use Test as described in CEC Publication L78-T-99.

In a still yet further form, the method produces and evaluates formulated products that would pass end use qualifying tests for lubricants, such as, but not limited to, the Caterpillar C13, API Sequence tests, etc. This further includes qualifying tests yet to be developed. End Use Tests can also be actual field performance results.

### BRIEF DESCRIPTION OF THE DRAWINGS

FIG. 1 schematically illustrates an apparatus for conducting a two-phase high throughput deposit test, in accordance herewith;

FIG. 2 illustrates the different oxidation pathways a lubricant can take leading to deposits.

FIG. 3 is a diagram illustrating the Elemental Sets that relate lubricant “intermediate” testing to final end use qualifying test results;

FIG. 4 presents Volkswagen TDi2 (VWTDi2) test results plotted against two-phase reactor panel deposits;

FIG. 5 presents VWTDi2 test results plotted against differential TGA test results; and

FIG. 6 presents predicted VWTDi2 test results plotted against actual VWTDi2 test results.

### DETAILED DESCRIPTION

Various aspects will now be described with reference to specific forms selected for purposes of illustration. It will be appreciated that the spirit and scope of the apparatus, products, compositions and methods disclosed herein are not limited to the selected forms. Moreover, it is to be noted that the figures provided herein are not drawn to any particular proportion or scale, and that many variations can be made to the illustrated forms. All numerical values within the detailed description and the claims herein are also understood as modified by “about.” Reference is now made to FIGS. 1-6, wherein like numerals are used to designate like elements throughout.

Throughout this disclosure, the word lubricant (or its derivatives) also refers to lubricants, greases, and various types of functional fluids (and their respective derivatives).

Referring now to FIG. 1, one form of an apparatus for evaluating deposit formation characteristics of lubricant samples 10 is shown. Apparatus 10 includes a reactor chamber 12 having a closed first end 14 and a second end 16. The closed first end 14 of reactor chamber 12 advantageously forms a lubricant sump 30. As shown, the second end 16 is open and may be vented to the atmosphere.

An electric heater 18 is provided for heating a test coupon 22. Test coupon 22 may be positioned directly upon electric heater 18 and may be affixed to coupon platform 20. Coupon platform 20 may be intimately affixed to electric heater 18 so as to minimize heat losses. As shown, electric heater 18 may be positioned within reactor chamber 12 and above lubricant sump 30. In this manner, heat transfer from electric heater 18 to lubricant sump 30 is minimized.

In one form, an air supply tube 32 is provided. Air supply tube 32 has a first end 38 in fluid communication with a source of air (not shown) and a second end 40 positioned adjacent test coupon 22. As may be appreciated by those skilled in the art, the source of air may be pressurized as, for example, by a pump or pressurized canister, or the like. The source of air may also be dried and filtered for consistency. In one form, air supply tube 32 is provided with a sample orifice 46, located between first end 38 and second end 40 of air supply tube 32.

A lubricant supply tube 34 is provided to withdraw the lubricant sample for testing. Lubricant supply tube 34 has a first end 42 positioned within lubricant sump 30 and in fluid communication with a lubricant sample L. In one form, lubricant supply tube 34 has a second end 44 positioned within sample orifice 46 of said air supply tube 32 and forming a Y-connection 48, wherein the flow of air through air supply tube 32 serves to siphon lubricant sample L from lubricant sump 30 and supply a mist of lubricant sample L and air to the face of test coupon 22. As such, it may be envisioned by those skilled in the art that apparatus 10 provides a unique two-phase deposit test having particular utility in a high throughput testing environment.

In one form, apparatus 10 may be provided with a sump heater 50 for heating lubricant sump 30. Sump heater 50 may include a liquid bath 52 heated by a resistance heater 54, as is conventional. As shown, reactor chamber 12 of apparatus 10 is positioned within liquid bath 52 to transfer heat thereto. A stirrer 56 may be provided for stirring the contents of lubricant sump 30. Stirrer 56 may be a magnetic laboratory stirrer.

Apparatus 10 may also be provided with a temperature sensor 28 for measuring the temperature of the lubricant sample L within lubricant sump 30. Temperature sensor 28 may be a thermocouple, thermister, or the like. Apparatus 10 may also be provided with a temperature sensor 26 for measuring the temperature of the test coupon 22. As with temperature sensor 28, Temperature sensor 26 may be a thermocouple, thermister, or the like.

In one form, apparatus 10 is provided with an air flow meter 36 for measuring the flow of air to air supply tube 32. In another form, reactor chamber 12 comprises a conventional test tube.

In operation, air is forced through air supply tube 32, the flow of which is controlled through the use of air flow meter 36. The air passes through air supply tube 32 which intersects at Y-connection 48 with lubricant supply tube 34. As mentioned, the air flow causes a portion of lubricant sample L to be sucked up into the lubricant supply tube 34 and sprayed onto a hot metal test coupon 22. A portion of the sprayed lube forms a deposit on test coupon 22, with the remainder falling back down into the lubricant sump 30 together with the balance of lubricant sample L. The test coupon 22 is clipped onto electric heater 18 and thermocouple 26 measures the temperature of test coupon 22, which is controlled to the desired temperature by a conventional controller (not shown). As mentioned above, thermocouple 28 is used to measure the temperature of lubricant sample L in lubricant sump 30. Liquid (oil) bath 52 is used to control the temperature of the lubricant sump 30 to any desired temperature. Since second end 16 of reactor chamber 12 is open and vented to the atmosphere, volatile liquids are allowed to escape the test tube.

Lubricant sample L is circulated from lubricant sump 30 and sprayed onto the hot metal test coupon 22 continuously for a desired length of time after which the heater and air are turned off and the apparatus 10 with the lubricant sample L allowed to cool. After cooling, the test coupon 22 with deposit is removed, washed with heptane, dried and weighed to determine the amount of deposit that has formed. Other analyses can be performed on the deposit such as stereo optical microscopy to determine the volume of deposit, reflectance infrared to determine the chemistry of the deposit, etc. Used lubricant sample L is weighed and subtracted from the original weight of the fresh lubricant sample L to determine the weight percent of volatile material lost during the test. The used lubricant can also be subjected to other analyses such as viscosity change and infrared analysis (IR) to determine the amount of oxidation that has occurred and the additive depletion.

Typically a fixed amount of lubricating oil was placed in a test tube submerged in an oil bath. The bath temperature was maintained at a constant temperature with proper circulation. The bath temperature can be as low as 40° C. or as high as 140° C. A metal coupon (or specimen) was attached to a heating element and placed at a higher position above the oil bath where the coupon surface temperature must be at least 80° C. higher than the oil bath temperature. The coupon temperature could be as low as 225° C. or as high as 350° C. Proper air flow rate was regulated by flow meters and the air flow rate could be as low as 100 mL per minute or as high as 500 mL per minute. Other gases could also be used as carrier gas. A variety of metallurgy could be used for the metal coupons, aluminum, iron, steel, tin, gold, silver, and stainless steel. Different coupon geometry, shape and size, surface finishing, length, width and thickness can be used. Typical coupon weight is in the range of 1 to 20 grams and it is highly desired to keep the variations minimal from coupon to coupon. The test duration could also be as short as 30 minutes or as long as 24 or even 120 hours.

Oxidation proceeds via a hydroperoxide radical mechanism and thermal decomposition proceeds through carbon-carbon chain scission. Most studies emphasize the initial reaction rate processes. However, as degradation reactions proceed to higher conversions, oil-insoluble products such as sludge, varnish, and residue, begin to appear. These oil-insoluble products generally are attributed to multiple condensation and/or polymerization reactions under oxidative thermal conditions. Chain propagation and branching reactions produce many organic species, some of which are reaction intermediates and intermediate products which undergo subsequent reactions. Overall, two major reaction pathways can be identified: decomposition into smaller molecular fragments, and polymerization into larger molecules.

In accordance herewith, another bench test is also used to measure the stability of lubricant sample L. In one form, thermal gravimetric analysis (TGA) is used to measure the thermal properties of lubricant sample L, including both volatility and oxidation/deposit tendencies. As is known to those skilled in the art, there are several known procedures for conducting a TGA test. In a TGA experiment, oxidation occurs primarily at the air-oil interface. The sensitivity with which the TGA can detect oxidation is dependent on the weight change relative to the total initial weight of the oil and the detection limit of the TGA balance. Ideally, only a sufficient oil sample should be used to provide a uniform thin film over the surface of the sample pan. A thick oil film might cause oxygen diffusion rate as the rate limiting step, thus complicating the oxidation process. Too little oil might make balance sensitivity the limiting factor and result in less precision. Heating rate affects the rate of reaction significantly. Too fast a heating rate would accelerate the degradation processes in a relatively short time, making measurement difficult. Too slow a heating rate would exaggerate the evaporation process, thus affect the precision of the method.

In one form, the method disclosed by S. M. Hsu and A. L. Cummings, “Thermogravimetric Analysis of Lubricants” in SAE SP 558, “Lubricant and Additive Effects on Engine Wear,” Vol. 51, 1983, is used as a measure of oxidative stability. In this method, an oil is evaluated in thermal gravimetric analysis separately under an air atmosphere and then under an inert gas (i.e. argon or nitrogen), and then the graphs are subtracted to give the amount of oxidation vs. volatility only. This method may be conducted as follows: weigh the amount of lubricant sample in the TGA pan (should range from 1 mg to 50 mg). Place pans into carrousel to run in high throughput mode. Run temperature profile to monitor sample weight loss vs. time or temperature. A typical temperature profile is obtained by ramping rapidly from room temperature to a temperature below the engine operating temperature (such as 150 C), then ramp slowly to a temperature above engine operation temperature (such as 375-400° C.). Resume rapid ramping to approximately 600° C.

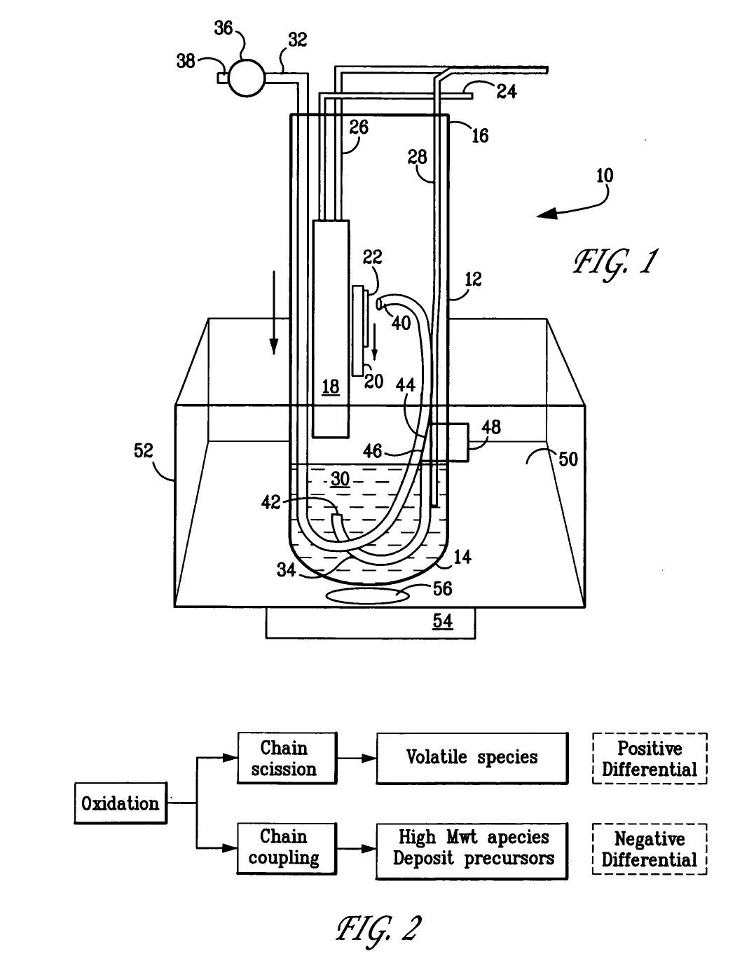

Referring now to FIG. 2 the different oxidation pathways a lubricant can take leading to deposits is shown. When comparing a TGA test conducted with air to one conducted using an inert gas, there can either be a positive or a negative differential between the curves, indicating the relative amount of volatilization vs. deposit formation.

Provided herein are techniques to rapidly produce and evaluate lubricant candidates to determine their probable success in end use engine or equipment testing. Mathematical models may be employed to predict the components and/or lubricant formulations that will lead to successful end use qualifying test results.

In one form, provided is a method of predicting lubricant deposit formation in an end use engine test. The method includes the steps of providing an Elemental Set of Samples having at least a first member and a second member, conducting an End Use Test for each member of the Elemental Set of Samples and obtaining a set of End Use Test Results, conducting a first deposit test for each member of the Elemental Set of Samples and obtaining a first set of Intermediate Test Results, conducting at least a second deposit test for each member of the Elemental Set of Samples, the second deposit test utilizing a different test procedure than the first deposit test, and obtaining at least a second set of Intermediate Test Results and performing a regression analysis on each set of Intermediate Test Results and the set of End Use Test Results to obtain a predictive model of lubricant deposit formation in an end use engine test.

In another form, provided is a method for predicting whether a candidate lubricant sample will pass an End Use Test. The method includes the steps of providing an Elemental Set of Samples having at least a first member and a second member, conducting an End Use Test for each member of the Elemental Set of Samples and obtaining a set of End Use Test Results, conducting a first deposit test for each member of the Elemental Set of Samples and obtaining a first set of Intermediate Test Results, conducting at least a second deposit test for each member of the Elemental Set of Samples, the second deposit test utilizing a different test procedure than the first deposit test, and obtaining at least a second set of Intermediate Test Results, performing a regression analysis on each set of Intermediate Test Results and the set of End Use Test Results to obtain a predictive model of lubricant deposit formation in an end use engine test, the predictive model including pass/fail criteria, subjecting the candidate lubricant sample to the first deposit test and the at least second deposit test and obtaining candidate lubricant sample test results and comparing the candidate lubricant sample test results with the pass/fail criteria thereby determining whether the candidate lubricant will pass the selected end use test.

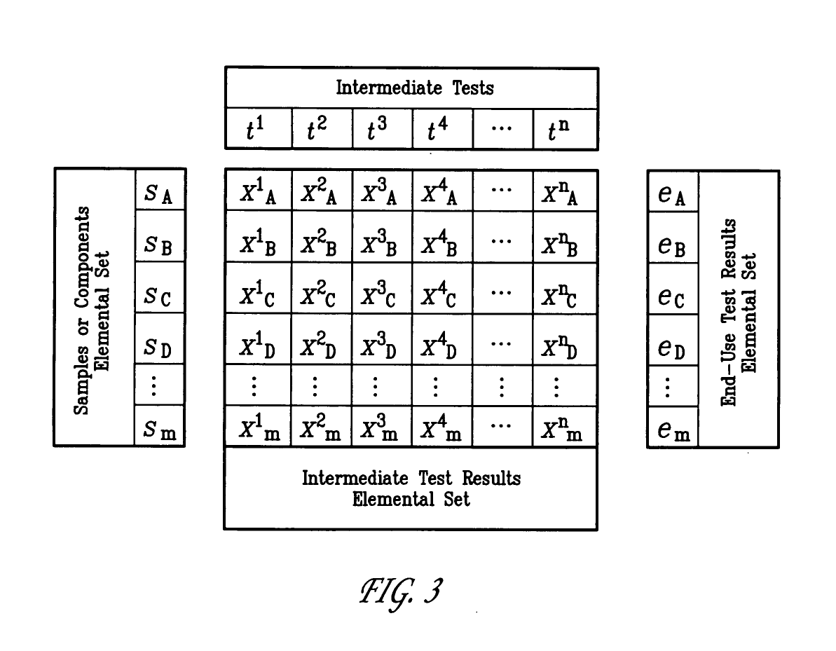

FIG. 3 presents a diagram indicating the stages of the current method that relate lubricant “intermediate” testing to final end use qualifying test results. The diagram lists three Elemental Sets: a “Samples” or “Component” Elemental Set, an “Intermediate Tests” Elemental Set and an “End Use Test Results” Elemental Set. When the members of any two of these Elemental Sets are defined, the method disclosed herein allows one to determine the more predictive members of the third Elemental Set.

As may be appreciated, any item that would fit into any of the boxes of FIG. 3 would be considered a member of that Elemental Set. Therefore, any one test result of an end use qualifying test would be a member of the Elemental Set of End Use Test Results. Similarly, each sample, or component of a sample, would be a member of the Elemental Set of all Samples or Components. For example, in one form, the candidate samples and their formulations would constitute the “Sample” Elemental Set. How each of those samples performed on the end use qualifying tests would populate the “End Use Results” Elemental Set. The members of the “End Use Results” Elemental Set may include a simple pass/fail determination of the end use qualifying test or may give more detailed indications of the quality of passing the test.

Once these known inputs are selected for the Samples Elemental Set and End Use Results Elemental Set, a set of intermediate tests is chosen to form the Intermediate Tests Elemental Set. As disclosed hereinabove, the two-phase high throughput deposit test and the TGA test may be selected. Additional tests relating to deposit formation may also be chosen. These tests may be classical bench tests, but in this form, the tests are capable of being performed in a high throughput environment.

Once an Elemental Set of Intermediate Tests has been selected, those intermediate tests are run on each sample. These results are then analyzed using any variety of modeling techniques. Some simple non-limiting examples of modeling techniques include generalized linear regressions such as multiple linear regression, principal components, ridge regression, each of which is encompassed herein. For more complex data sets non-linear regression techniques such as neural networks may be employed. One of ordinary skill in the art is well aware of other modeling techniques that could easily be employed herein.

Most regression models intended to assess a pass/fail criteria are fully encompassed herein. For example, neural networks, principal component regression, and other linear or non-linear regression models could be written in the general form:

e_{A}=F(x¹_{A}, x²_{A}, x³_{A}, . . . , xⁿ_{A})+∈

or

e_{A}=F(X_{A})+∈;

where

X_{A}=(x¹_{A}, x²_{A}, x³_{A}, . . . , xⁿ_{A})

Predicted Performance=F(X_{A})=F(x¹_{A}, x²_{A}, x³_{A}, . . . , xⁿ_{A})

∈: Error term, comprising of errors in the e_{A}, x¹_{A} and F lack-of-fit

If Passing Criterion is, e.g.,: e_{A}<F₀

Predicting Passing Criteria based on x¹_{A}: F(x¹_{A}, x²_{A}, x³_{A}, . . . , xⁿ_{A})<F₀,

where “F” is a continuous performance-predicting function of “n” variables, “A” is one member of the Elemental Set of Samples, x¹_{A} is the result of the first Intermediate Test performed on Sample “A”, “e_{A}” is the member of the End User Test Elemental set corresponding to Sample “A”, and F₀ is the pass/fail threshold. For such a model, there exists a subspace, or region, in the (x¹, x², x³, . . . , xⁿ) “space” (the space of Intermediate Tests results) that maps, through the function F, to the passing criteria. This can be extended to multiple criteria by choosing different values of F₀, thereby creating different boundaries in the Intermediate Test Space which delimit different levels of lubricant performance.

As more criteria levels are added, in the limit, all known regression models are a subset of this generalized boundary-based classification approach. As non-limiting examples, Principal Component Regression, Multiple Linear Regressions and Neural Net Regressions fit into this model. One form uses a back propagating neural net. Back-propagation (or “backprop”) neural nets are comprised of inter-connected simulated neurons. A neuron is an entity capable of receiving and sending signals and is simulated by software algorithms on a computer. Each simulated neuron (i) receives signals from other neurons, (ii) combines these signals, (iii) transforms this signal and (iv) sends the result to yet other neurons. Typically, a weight, modifying the signal being communicated, is associated with each connection between neurons.

A neural net attempts to find the values of each coefficient (a, b, c, d, etc.) that will map to the End Use Result for that Sample. While we commonly think of linear regressions, each level applies a function (for example, a sigmoid) upon each of the coefficients to produce a new set of coefficients (w₁, w₂, w₃, w₄, etc.). This may occur for as many layers as desired.

Once the coefficients (a, b, c, d,) are determined such that they map the Intermediate Tests Results to the Final End Use Test Result for that specific Sample to a desired degree of Error, the neural net then applies those coefficients to the Intermediate Tests results for the next Sample. If the coefficients do not map to the End Use Test for the Second Sample to an acceptable error level, then weights are applied to each coefficient and the process is repeated until coefficients are determined that produce an acceptable error level for both samples. This process is continued until a mapping function is determined that produces an acceptable level of error between all Intermediate Tests and their respective End Use Test Results.

The “information content” of the net is embodied in the set of all these weights that, together with the net structure, constitute the model generated by the net. The back-prop net has information flowing in the forward direction in the prediction mode and back-propagated error corrections in the learning mode. Such nets are organized into layers of neurons. Connections are made between neurons of adjacent layers: a neuron is connected so as to receive signals from each neuron in the immediately preceding layer, and to transmit signals to each neuron in the immediately succeeding layer.

A minimum of three layers is utilized. An input layer, as its name implies, receives input. One or more intermediate layers (also called hidden layers because they are hidden from external exposure) lie between the input layer and the output layer which communicates results externally. Additionally, a “bias” neuron supplying an invariant output is connected to each neuron in the hidden and output layers. The number of neurons used in the hidden layer depends on the number of the input and output neurons, and on the number of available training data patterns. Too few hidden neurons hinder the learning process, and too many degrade the generalizing capability of the net.

An outcome from a given input condition is generated in the following way. Signals flow only in the forward direction from input to hidden to output layers. A given set of input values is imposed on the neurons in the input layer. These neurons transform the input signals and transmit the resulting values to neurons in the hidden layer. Each neuron in the hidden layer receives a signal (modified by the weight of the corresponding connection) from each neuron in the input layer. The neurons in the hidden layer individually sum up the signals they receive together with a weighted signal from the bias neuron, transform this sum, and then transmit the result to each of the neurons in the next layer.

Ultimately, the neurons in the output layer receive weighted signals from neurons in the penultimate layer and the bias, sum the signals, and emit the transformed sums as output from the net. The net is trained by adjusting the weights in order to minimize errors. In the learning (or training) mode, the net is supplied with sets of data comprised of values of input variables and corresponding target outcomes. The weights for each connection are initially randomized. During the training process, the errors (which are the differences between the actual output from the net and the desired target outcomes) are propagated backwards (hence the name “back-propagation”) through the net and are used to update the connecting weights. Repeated iterations of this operation result in a converged set of weights and a net that has been trained to identify and learn patterns (should they exist) between sets of input data and corresponding sets of target outcomes. More information concerning making and using neural nets may be found at J. Leonard & M. A. Kramer, Computers and Chemical Engineering, v. 14, #3, pp. 337-341, 1990.

Neural nets, after being trained on data, result in a correlative model that predicts a quantitative outcome when presented with a set of independent parameters as input. This quantitative result enables determination of a set of desirable input variables which maximize the performance (i.e., model outcome). This is accomplished by deploying suitable optimization techniques, viz., genetic algorithms.

Once an acceptable mapping is achieved by neural networks to estimate the function F above, a classification scheme is selected to limit the mapping function (and therefore the contours of the selected region in x space) to a particular set of mappings. For example, the uses disclosed herein develops a neural network model that relates families of X_{c} vectors (wherein each X_{c} vector represents the results of selected intermediate tests on a single Sample, sometimes known as a “calibration set” or “training set”) to the corresponding engine test results. Then, future bench test screener result vectors Xₚ (where Xₚ is the results of the intermediate tests on a previously unknown Sample, Xₚ is sometimes known as the “prediction set”) can be tested with the neural network function F, against the F₀ threshold. Some will “pass”, some will “fail” the neural network model.

It is possible to create a map of the pass/fail regions by using regression techniques. For example, one way of implementing this, is to “run” large numbers of simulated Xₜ (i.e., a universe of Sample or Component Sets) vectors, and then build the corresponding “pass” and “fail” regions in X_{C} space. Those classification models would yield the same prediction results as the neural network regression model. Once F is available, it can be applied across the screener space to make contours to predict varying pass or fail results at various pass/fail criteria.

For data sets comprising a limited number of measurements (e.g., <100), an “all possible combinations (APC) of variables” approach (e.g., regressions or classifications) may be done with typical desktop computational power. These approaches typically attempt to find a fixed number of variables, e.g., n, and try the regression, or classification, in all possible combinations of the original available, measured variables. For example, if 10 screener test results are available, and a model with just 5 variables is desired, it is possible to try combinations [1 2 3 4 5], [1 2 3 4 6], [1 2 3 4 7] . . . [1 2 3 4 10] . . . all the way until [6 7 8 9 10], for a total of 252 regressions. In a typical 3.2 GHz Pentium 4 machine, that calculation can be completed in just 0.25 seconds.

For larger data sets, while it is possible to somewhat optimize the APC algorithms, there are numerous strategies to identify ideal combinations of predictive variables. For example, a forward step-wise methodology sequentially selects variables one at a time, according to their incremental classification, or prediction value. For example, if there were ten available Intermediate Tests (per sample), this method would first identify the best predictor of the ten. Next, the method would look at the remaining nine Intermediate Tests and select the next most predictive Tests, that when combined with the original selected most predictive Intermediate Test, yields the best pair of Intermediate Test predictors. The procedure is repeated until the desired number of variable, n, is selected. The number of variables may also estimated, using testing data sets, or validation procedures, do establish the best number of variables to utilize.

It is clear that the methods disclosed herein are not limited to just neural network models, but may be applied to any other regression model. Furthermore, the current method has the potential of being more robust than many regression methods, as a misclassification of one, or even a handful, of results would not seriously impair the determination of the preferred regions. Moreover, it is noted that this methodology enables models that are more parsimonious than that of regression, as it does not force preconceived function shapes to the relationship between screener tests and the engine and rig test results.

The classification model approach does not significantly limit the ability to obtain several levels of performance out of a model. The present method perceives gradations of success as well as a simple pass/fail model. Contours in the X-space of single bench test results may be developed for each desired level of performance, or a simple continuous regression model may be used to determine the contours.

Further, the methods disclosed herein are not limited to linearly modeled spaces. Indeed, lubricant formulation is rife with examples of non-linear responses and therefore the methods disclosed herein are particularly suited to lubricant formulations.

This forms disclosed herein are illustrated by the following Example.

### EXAMPLE

In accordance herewith, a TGA test is run under the following optimized conditions (either with air or an inert gas): 1) ramp @100° C./min from room temperature to 280° C., 2) ramp @5° C./min from 280° C. to 400° C., 3) ramp @100° C./min from 400° C. to 550° C. For acceptable repeatability it is important to closely control the amount of oil tested in the TGA. In one form, the weight used was 10 mg+/−3% or 10 mg+/−0.3 mg.

A 20 gram sample of lubricating oil was placed in a test tube submerged in an oil bath. The bath temperature was maintained at a constant temperature of 100° C. with proper circulation. A metal coupon (or specimen) was attached to a heating element and placed at a higher position above the oil bath. The coupon temperature ranged from 225° C. to 350° C. Proper air flow rate was regulated by flow meters and the air flow rate was 320 mL per minute. The coupon weight is approximately 12 grams. The test duration ranged from 30 minutes to 120 hours.

A Volkswagen TDi2 engine is used to evaluate lubricant deposit tendencies. The test is known as the Direct Injection Diesel Ring Sticking and Piston Cleanliness Test and is a required test for passenger vehicle lubricant (PVL) oils in Europe. Details of the test are available in CEC-L-78-T-99, the contents of which are hereby incorporated by reference for all that they disclose. Twenty-one oils that were tested in the TDi2 test were also tested in the two-phase deposit test and differential TGA. While far too lengthy to describe in this disclosure, one of ordinary skill in the art recognizes that the methods disclosed herein do not rely upon this specific End Use Test, but upon any End Use Test that one may wish to model.

When the results of each of these tests separately were used to correlate with the TDi2 rating, very poor correlations were achieved as shown in FIGS. 4 and 5. This is expected as an engine test is very complicated with multiple pathways for deposit formation possible. The data used to generate FIGS. 4 and 5 are in the table below.

TABLE B

| | mg Deposit in 2- | Differential TGA @ |
|---|---|---|
| Tdi2 Rating | Phase Deposit Test | 5 Minutes |
| 49 | 20.1 | 0.6 |
| 51 | 13.4 | 2.7 |
| 54 | 9.0 | −5.6 |
| 57 | 4.8 | −5.1 |
| 58 | 17.0 | −2.4 |
| 59 | 3.9 | 0.9 |
| 61 | 3.6 | −1.7 |
| 63 | 2.5 | −5.9 |
| 63 | 10.6 | −5.2 |
| 65 | 7.4 | −4.2 |
| 65 | 5.5 | −3.4 |
| 66 | 9.1 | −2.4 |
| 66 | 3.3 | −3.1 |
| 66 | 2.2 | −2.6 |
| 67 | 1.3 | −1.3 |
| 67 | 4.0 | −1.6 |
| 67 | 4.0 | −0.7 |
| 68 | 3.9 | −1.2 |
| 69 | 7.1 | −0.2 |
| 69 | 4.7 | −1.0 |
| 71 | 1.9 | −1.5 |
| 71 | 1.5 | −1.2 |

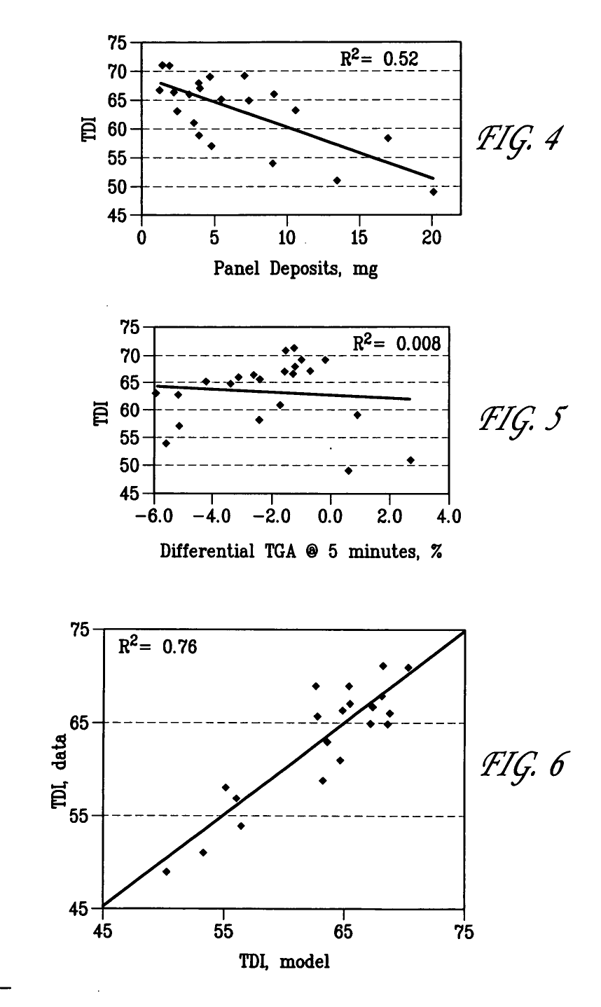

Surprisingly, when the results of these two bench tests are combined in the best possible mode as determined using Matlab, the R² improves to 0.76 as shown in FIG. 6.

An R² of 0.76 is comparable to the variability of the TDi2 test itself, indicating this is an excellent correlation, which spans the expected range of TDi2 results. Therefore so by combining the results of two or more deposit bench tests, one should be able to accurately predict TDi2 results. These accurate predictions would not be possible only using the results of one bench test as it currently practiced and in the literature.

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of this disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which this disclosure pertains.

When numerical lower limits and numerical upper limits are listed herein, ranges from any lower limit to any upper limit are contemplated.

What is claimed is:

1. An apparatus for evaluating deposit formation characteristics of lubricant samples, comprising:
(a) a reactor chamber having a closed first end and a second end, said closed first end of said reactor chamber forming a lubricant sump and said second end open to the atmosphere;
(b) an electric heater for heating a test coupon positioned thereon, said electric heater positioned within said reactor chamber, above said lubricant sump;
(c) an air supply tube, said air supply tube having a first end in fluid communication with a source of air and a second end, said second end positioned adjacent the test coupon, said air supply tube having a sample orifice located between said first end and said second end of said air supply tube; and
(d) a lubricant supply tube, said lubricant supply tube having a first end positioned within said lubricant sump and in fluid communication with a source of lubricant and a second end, said second end positioned within said sample orifice of said air supply tube.

2. The apparatus of claim 1, further comprising a sump heater for heating said lubricant sump.

3. The apparatus of claim 2, wherein said sump heater comprises a liquid bath heated by a resistance heater, said reactor chamber positioned within said liquid bath.

4. The apparatus of claim 3, further comprising a stirrer for stirring the contents of said lubricant sump.

5. The apparatus of claim 4, further comprising a temperature sensor for measuring the temperature of the lubricant sample within said lubricant sump.

6. The apparatus of claim 1, further comprising a temperature sensor for measuring the temperature of the lubricant sample within said lubricant sump.

7. The apparatus of claim 6, wherein said temperature sensor for measuring the temperature of the lubricant sample within said lubricant sump is a thermocouple.

8. The apparatus of claim 1, further comprising a temperature sensor for measuring the temperature of the test coupon.

9. The apparatus of claim 8, wherein said temperature sensor for measuring the temperature of the test coupon is a thermocouple.

10. The apparatus of claim 1, further comprising an air flow meter for measuring the flow of air to said air supply tube.

11. A method of predicting lubricant deposit formation in an end use engine or machinery test, the method comprising:
providing an Elemental Set of Samples having at least a first member and a second member;
conducting an End Use Test for each member of the Elemental Set of Samples and obtaining a set of End Use Test Results;
conducting a first deposit test for each member of the Elemental Set of Samples and obtaining a first set of Intermediate Test Results;
conducting at least a second deposit test for each member of the Elemental Set of Samples, the second deposit test utilizing a different test procedure than the first deposit test, and obtaining at least a second set of Intermediate Test Results; and
performing a regression analysis on each set of Intermediate Test Results and the set of End Use Test Results to obtain a predictive model of lubricant deposit formation in an end use engine test.

12. The method of claim 11, wherein the regression analysis is selected from generalized linear regression analysis and non-linear regression analysis.

13. The method of claim 11, wherein the regression analysis is a neural net regression analysis.

14. The method of claim 11, wherein each set of Intermediate Test Results is obtained by high throughput experimentation.

15. The method of claim 11, wherein the first set of Intermediate Test Results is obtained through the use of a two-phase high throughput deposit test.

16. The method of claim 11, wherein the two-phase high throughput deposit test is conducted using an apparatus, the apparatus comprising a reactor chamber having a closed first end and a second end, said closed first end of said reactor chamber forming a lubricant sump and said second end open to the atmosphere; an electric heater for heating a test coupon positioned thereon, said electric heater positioned within said reactor chamber, above said lubricant sump; an air supply tube, said air supply tube having a first end in fluid communication with a source of air and a second end, said second end positioned adjacent the test coupon, said air supply tube having a sample orifice located between said first end and said second end of said air supply tube; and a lubricant supply tube, said lubricant supply tube having a first end positioned within said lubricant sump and in fluid communication with a source of lubricant and a second end, said second end positioned within said sample orifice of said air supply tube.

17. The method of claim 16, wherein the second set of Intermediate Test Results is obtained through the use of a thermogravimetric analysis test.

18. The method of claim 11, wherein the second set of Intermediate Test Results is obtained through the use of a thermogravimetric analysis test.

19. The method of claim 17, wherein the End Use Test is a Volkswagen TDi End Use Test as described in CEC Publication L78-T-99.

20. The method of claim 11, wherein the End Use Test is a Volkswagen TDi End Use Test as described in CEC Publication L78-T-99.

21. A method for predicting whether a candidate lubricant sample will pass an End Use Test comprising:
providing an Elemental Set of Samples having at least a first member and a second member;
conducting an End Use Test for each member of the Elemental Set of Samples and obtaining a set of End Use Test Results;
conducting a first deposit test for each member of the Elemental Set of Samples and obtaining a first set of Intermediate Test Results;
conducting at least a second deposit test for each member of the Elemental Set of Samples, the second deposit test utilizing a different test procedure than the first deposit test, and obtaining at least a second set of Intermediate Test Results;
performing a regression analysis on each set of Intermediate Test Results and the set of End Use Test Results to obtain a predictive model of lubricant deposit formation in an end use engine test, the predictive model including pass/fail criteria;
subjecting the candidate lubricant sample to the first deposit test and the at least second deposit test and obtaining candidate lubricant sample test results; and
comparing the candidate lubricant sample test results with the pass/fail criteria thereby determining whether the candidate lubricant will pass the selected end use test.

22. The method of claim 21, wherein the first set of Intermediate Test Results is obtained through the use of a two-phase high throughput deposit test.

23. The method of claim 21, wherein the two-phase high throughput deposit test is conducted using an apparatus, the apparatus comprising a reactor chamber having a closed first end and a second end, said closed first end of said reactor chamber forming a lubricant sump and said second end open to the atmosphere; an electric heater for heating a test coupon positioned thereon, said electric heater positioned within said reactor chamber, above said lubricant sump; an air supply tube, said air supply tube having a first end in fluid communication with a source of air and a second end, said second end positioned adjacent the test coupon, said air supply tube having a sample orifice located between said first end and said second end of said air supply tube; and a lubricant supply tube, said lubricant supply tube having a first end positioned within said lubricant sump and in fluid communication with a source of lubricant and a second end, said second end positioned within said sample orifice of said air supply tube.

24. The method of claim 23, wherein the second set of Intermediate Test Results is obtained through the use of a thermogravimetric analysis test.

25. The method of claim 24, wherein the End Use Test is a Volkswagen TDi End Use Test as described in CEC Publication L78-T-99.
